(19) United States
(12) Patent Application Publication
(10) Pub. No.: US 2006/0236953 A1
(43) Pub. Date: Oct. 26, 2006

(54) Bird harness and leash

(76) Inventor: Stephen P. Hartman, Sunbury, OH (US)

Correspondence Address: NEAL T. HAUSCHILD, 4310 SUNBURY ROAD, GALENA, OH, 43021, US

(21) Appl. No.: 11/032,661

(22) Filed: Apr. 26, 2005

(51) Int. Cl. A01K 37/00

(52) U.S. Cl. 119/714

(57) ABSTRACT

The bird restraint system is a body harness allowing birds freedom to move about and fly while being secured to a specific limited area. This harness system makes it possible for flighted and unflighted parrots to be comfortably and safely taken to any location without the possibility of escaping the control of the handler. This harness is very lightweight, easy to install on the bird, and escape proof. The efficient, lightweight design allows the harness to be worn by birds as small as 75 grams with no restrictions for the largest birds (i.e. ostrich). The leash is incorporated into the harness system to facilitate installation, and; since the leash and harness are one system, the bird is unable to disconnect the leash from the harness. The leash is made of elastic shock cord to absorb impact and reduce the risk of injury.

### CROSS REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF INVENTION

Pet birds, as other animals, require exercise and some freedom to be truly mentally and physically healthy. The pet bird industry is relatively new, about 30 years, and only recently has this concept begun to have wide acceptance. New and old pet bird owners today are understating the needs of a pet bird to thrive, and have begun to understand the necessity of flight and limited freedom to make a bird healthy. A new mindset is necessary to provide safe and effective harness and leash restraint systems for birds.

Birds differ from other animal species in significant ways. Birds fly and may reach the end of a leash at greater speeds than other animals. Birds are lighter weight relative to their body volume making them more fragile. Birds are more concerned than other animals about foreign objects making contact with their body or feathers. Feathers are important to birds for defensive posturing and flight. Being a prey species, innate defense responses are greatly heightened or that of other commonly kept pet species. Birds are more concerned than other animals about foreign objects making contact with their body because it may reduce their ability to fly. Flight is a birds first line of defense. Most other species where harnesses are used do not flee as a first line of defense, and are not concerned in this manner. Birds have not been kept as pets for as many years as other pet and farm animals and have not reached the same point of domestication that would allow the owner to work with and manipulate the animal to install a harness. Most humans have not yet worked with birds long enough to have developed the ability to manipulate their behavior and train them to allow installation of a difficult to install harness. Pet birds do not need to wear a collar or harness for the standard reasons of other captive animals Birds do not need to wear a collar or harness for holding identification information. It is not safe or customary to tether birds without supervision as it is with other animals like dogs or horses.

In the past it was the norm to render pet birds flightless for several reasons. The assumption was that flightless pet birds would be safer in a domestic environment. Little was know about the ability of pet birds to learn and adapt in captivity. Since the historic mind set was to render pet birds flightless, few owners taught the birds to come on command. It was necessary to keep the bird flightless so it would not accidentally fly away. Birds that had their wings clipped and rendered flightless at a young age did not develop the ability to navigate. As adults, when they molted new feathers, they did not have the navigation skills to turn around and come back, and sometimes accidentally flew away. Lack of understanding of how easy it is to potty train a pet bird also promoted the idea of rendering a bird flightless. Lack of understanding of behavior training possibilities kept owners from training their pet birds not to destroy the home the way an owner would train pet dog.

New information regarding the needs of pet birds' mental and physical development, and mental and physical maintenance, is leading the industry to encourage development of the concept of a flighted pet bird. To this end, it is important to develop a safe and effective harness to allow pet birds to exercise and fly without the danger of escape. There is also a need to keep the bird safe from other pets and wild animals, notably hawks and other predatory birds.

Past efforts to develop bird restraint system systems incorporated fatal errors that limit utility of the harnesses. Most notably, all of the harness to date utilize a detachable leash. Most birds use their beaks as effectively as our human fingers, and can detach the leash from the harness as fast as a human. The currently available harnesses have leash attachments that utilize a [Velcro] hook and loop strap and or a slip clip link (like the clip that holds a dog leash to a dog collar). The ability of a bird to quickly undo both systems severely compromises the utility of the harness and leash system.

Currently available harnesses tend to be bulky, stiff complicated in design and difficult to install. Since most pet birds are not trained from hatching to accept the owner manipulating their bodies to install the harness, most will not accept the harnesses currently available. Difficult installation of the harness causes even compliant birds to refuse the harness after a few installations.

Other harnesses and leash systems have multiple pieces with metal attachments that attract the birds attention. This preoccupation of the bird to the harness limits the birds' ability to freely explore and enjoy his freedom when wearing the existing harnesses.

One harness and leash system utilizes a belt (nylon or polypropylene strap) where the end of the belt has to pass through the slide (buckle) to put the harness on and take it off. This process is similar to the belts humans utilize to hold up pants. Within as little as one installation the end of the belt will have been chewed by the parrot. Once chewed it is difficult to pass the chewed tip of the belt through the slide to reinstall the harness. This difficulty leads to the owner becoming frustrated at the difficulty, and the bird becoming frustrated at the extended time for installation. The situation leads to most pet birds aggressively avoiding the harness.

Currently available harness systems have detachable leashes that attach on the back and or breast of the bird This poses a problem when the bird accidentally flies to the end of the leash and can be flipped over if the point of attachment is not proximate to the handle of the leash.

A trend is starting to teach birds to fly in a large circle on the end of a long lead. A harness with lead attachment points on the back or breast of the bird tends to put a rotational stress on the birds as it fly's in a circle at the end of the lead. This new harness and leash system incorporates a leash/belt system that freely rotates, thus, the point where the leash becomes the belt can always be closest to the handler holding the end of the lead.

One current system that doubles as a restraint harness system has a primary function as a bird diaper. Current understanding of how easy it is to potty train a pet bird in as little as 72 hours is rendering this product obsolete.

The bird diaper and harness wraps around the birds body similar to a shirt on a human. This presents a very dangerous situation where the bird is unable to regulate its body temperature. Birds regulate their body temperature by moving their feathers closer to or further away form their body. When further away from the body the feathers trap air and heat. To cool themselves a bird holds feathers tight to the body allowing heat to dissipate quickly. A bird wearing the bird diaper-harness system is unable to move their feathers.

In conclusion, the pet bird industry has matured to a point where it is necessary to have available, a functional harness leash system for the industry to progress.

### BRIEF SUMMARY OF THE INVENTION

Harness and leash systems currently available developed along the lines of harness and leash systems utilized by other animals, including but not limited to horses, dogs, cats and ferrets. A new mindset is necessary to provide safe and effective harness and leash restraint systems for birds. Currently available bird restraint systems have several previously existing problems. A functional bird restraint system must be safe and user friendly. The Bird restraint system is superior to the existing harness leash systems in several ways.

Currently, birds can quickly disconnect leads from a harness. Birds cannot disconnect this leash because the leash is a continuation of the belt on the harness. Instead of the belt being only long enough to pass through the slide (buckle), it continues on to function as the leash. The leash can extend out as far as desired away from the bird. The end of the leash strap folds back on itself and is secured to the leash to form a handle that can be slipped over the hand and wrist.

Currently, birds suffer significant impact when reaching the end of the lead at high speeds. On this bird restraint system the belt/leash converts from the standard strap ⅜″ strap material to a light weight elastic cording. This lightweight cording can start as close as a few inches from the birds' body and continues to the handle.

This change of material making up the leash serves at least two purposes. The effective weight of the harness on the bird is a combination of the harness and the portion of the leash that is exerting a weight on the bird. The elastic cording for the smallest species can be as thin as 1/16inch, significantly lighter than the standard strap material. The elastic properties of the cording serves as a shock absorber. A bird that rapidly and unexpectedly reaches the end of the leash can be injured from the impact. This shock-absorbing characteristic is especially important during the bird initial training phase.

Currently, materials used are too heavy in relation to the weight of the smaller birds, too restrictive, and are not flexible enough. The standard strap material used in the currently available leash and harness systems are ˜ 1/15^{th} of an inch thick and ⅜^{th} inches wide. To allow for greater flexibility, lighter weight, and less restrictive materials, the new material used in the bird restraint system is as thin as ˜ 1/23^{rd} of an inch thick and ⅜^{th} inches wide. This new material offers significant gains in flexibility, weight reduction and is less restrictive on the birds movement. The strap material for the collar portion of the smaller size harnesses, for birds under 150 grams, utilizes a much lighter and flexible weave, and in addition to the reduced thickness, is narrower in width at ¼^{th}″ inches.

Currently, the number and difficulty of attachments required to install harness make them difficult to install. Installation time is too lengthy for many birds to tolerate. Currently available harness systems require human fingers to manipulate very small slip clips (smaller version of the type used to secure dog leashes to dog collars) and feeding the end of the belt (⅜^{th} inch strap) through the slide (⅜^{th} inch buckle) on a moving bird. For this system, only one point needs to be adjusted to install the harness on the bird. Installation time is significantly less. The bird restraint system slips over the head of the bird, the wings are pulled through the space between the collar and belt and the belt is pulled through the slide until the belt is fitted to the body (waist) of the bird. This design results in only one adjustment and significantly less time for installation.

It is possible to damage the harness strap material and slip clips which easily render a harness unusable. Birds often chew the end of the belt making it difficult or impossible to pass through the slide on subsequent installations. Slip clips utilizing a swivel attachment where the clip attaches to parts of the collar and harness, and where the leash connects to the harness can be easily broken by the larger bird species with strong beaks. Once broken, the bird is free and the leash harness system is unusable. The new harness design can withstand more damage from bird and still function. The bird restraint system does not utilize any slip clips that can be broken, and does not have a belt end that can be damaged (chewed) to the point it can no longer pass through the slide (buckle).

Many pieces of materials used for construction draw birds' attention to seams, and pressure points on the body, lead to a distracted bird, and increased damage to harness. The new invention requires fewer pieces to construct the bird restraint system. The bird restraint system is made from only two pieces of material that touch the birds' body. One strap for the collar end, and one strap for the belt end are all that touches the birds' body. This simpler design reduces the birds' awareness and preoccupation with the installed harness.

Currently, leashes attach to a point on either the breast or back of the bird. If the bird unexpectedly reaches the end of the leash at a rapid speed and does not have its point of attachment proximal to the handler, the birds body will instantly be rotated, propelling the weight of the bird as far away from the handler as possible. This rotational movement can cause damage to the bird, and disorients the bird making a successful and safe flight and landing difficult. To move the leash from the breast to the back to facilitate the bird walking on the ground while the owner is in a standing positions requires the leash to be disconnected and reattached. This presents an escape opportunity while the leash is being moved. The new bird restraint system has a point of contact of leash to the body (where the belt becomes the leash) which self-adjusts as the orientation of the bird to the handler changes. On one side of the Bird restraint system, the point where the belt becomes the leash can slide from the point where the belt passes through the collar on the chest, upward to the point where the belt passes through the collar on the back.

Some harnesses wrap the birds' body in an outfit similar in scope to a shirt. Birds cannot properly regulate their body temperature when their feathers are unable to move closer to or away from their body. Birds regulate their body temperature by moving contour feathers closer to or further away from their body. Closer-to allows heat to escape, cooling the bird. Further-away traps air and slows heat loss keeping the bird warm. The new restraint system has a minimal amount of strap material making contact with the body of the bird.

### BRIEF DESCRIPTION OF THE DRAWINGS

1/16

FIG. 3A

Inside view of slide on belt/leash

2/16

FIG. 3B

Outside view of slide on belt/leash

3/16

FIG. 3C

Side view of slide on belt/leash

4/16

FIG. 3G

View of leash utilizing J-clips and or Clasps to connect strap and cord.

5/16

FIG. 3H

View of belt/leash connection of strap to cord

6/16

FIG. 4A

I-clip, open and closed.

7/16

FIG. 4B

Clasp, open and closed.

8/16

FIG. 5A

Front view of collar laying flat

9/16

FIG. 5B

Side view of collar lying flat

10/16

FIG. 5C

Side view of collar from installed perspective

11/16

FIG. 6A

Front view of collar, harness and leash on bird.

12/16

FIG. 6B

Side view of collar, harness and leash on bird.

13/16

FIG. 6C

Rear view of collar and harness on bird.

14/16

FIG. 6D

View of harness and leash in front of bird ready for installation.

5/16

FIG. 6E

View of right wing going into harness.

16/16

FIG. 6F

View of left wing going into harness.

### DETAILED DESCRIPTIONS OF THE INVENTION

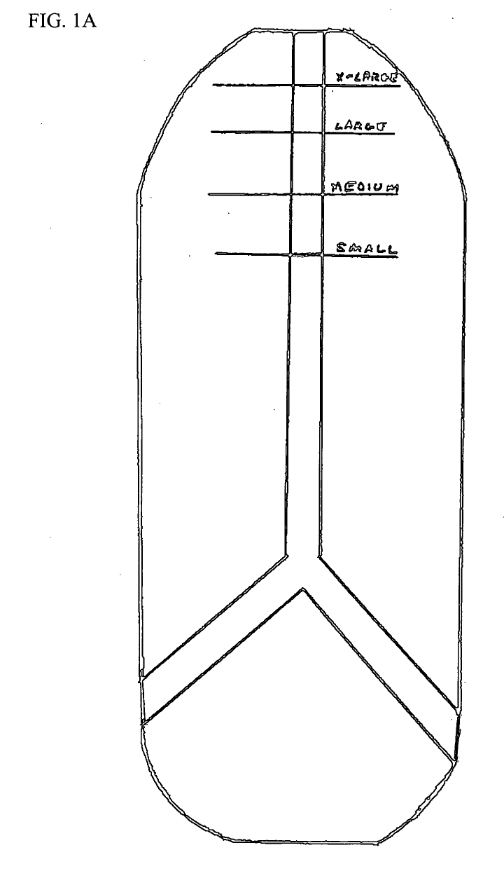

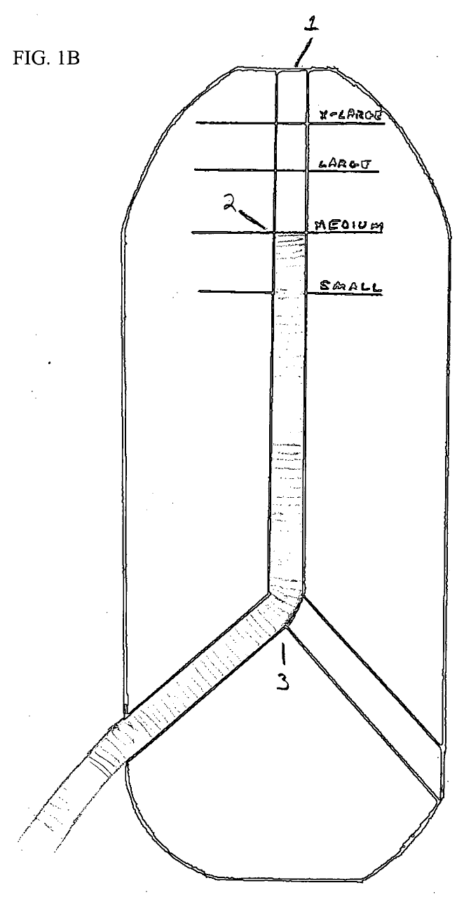

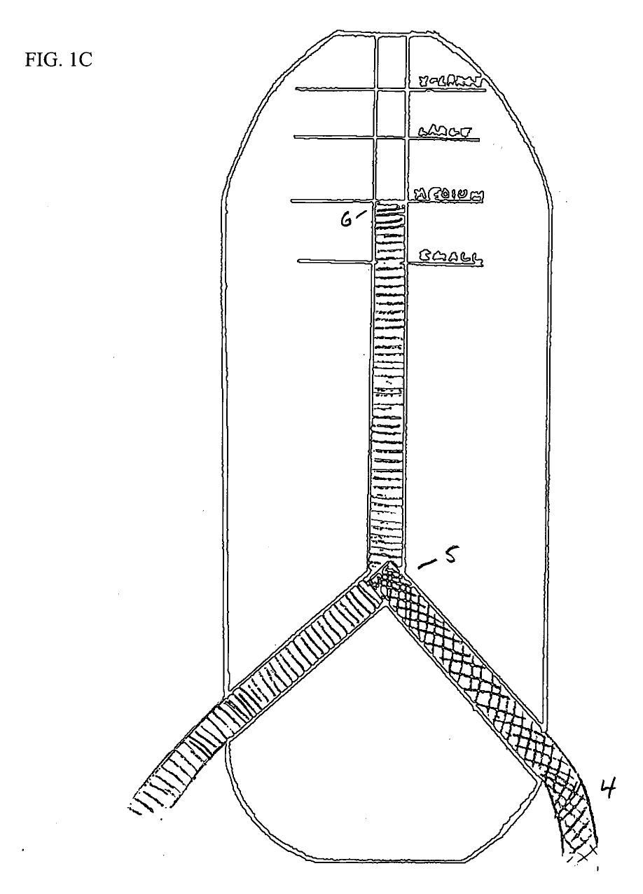

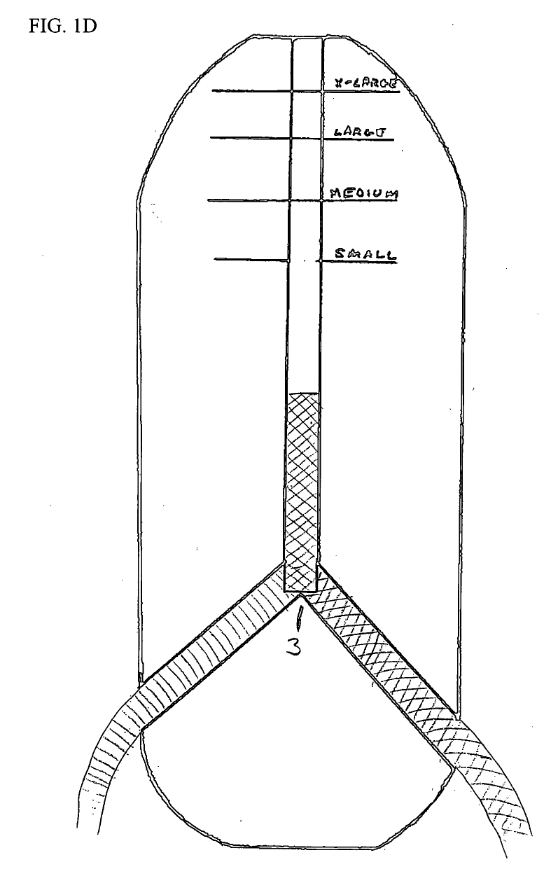

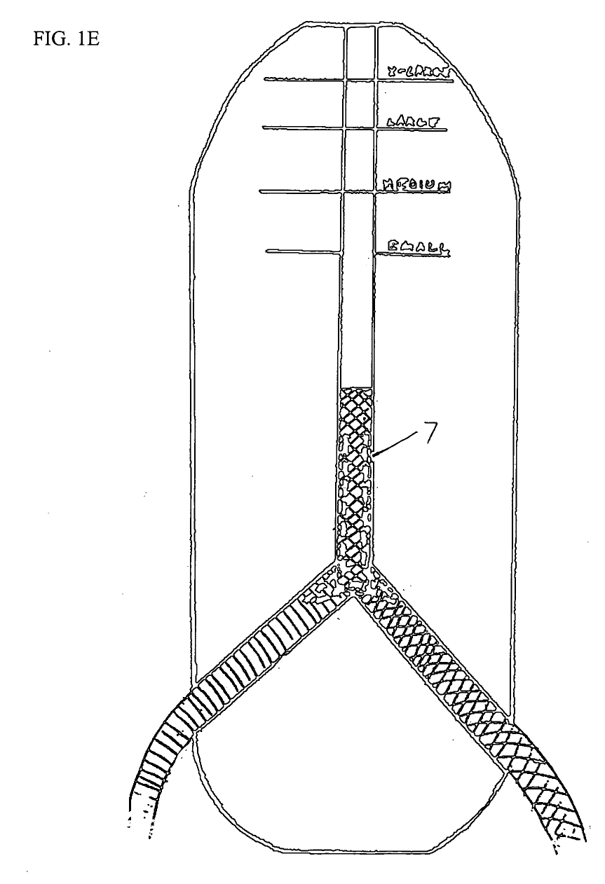

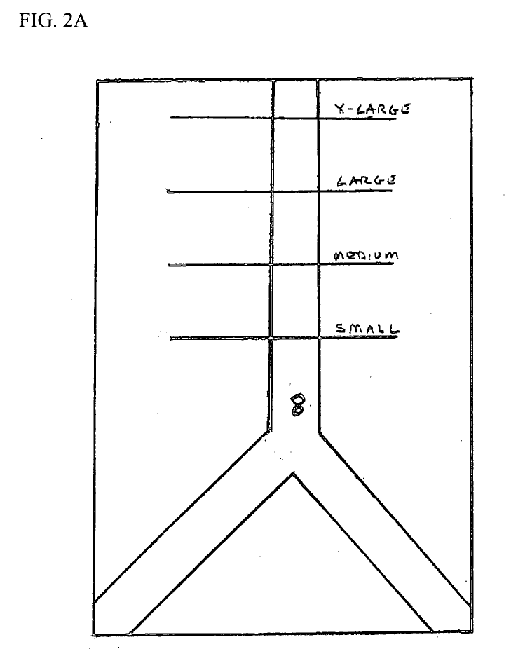

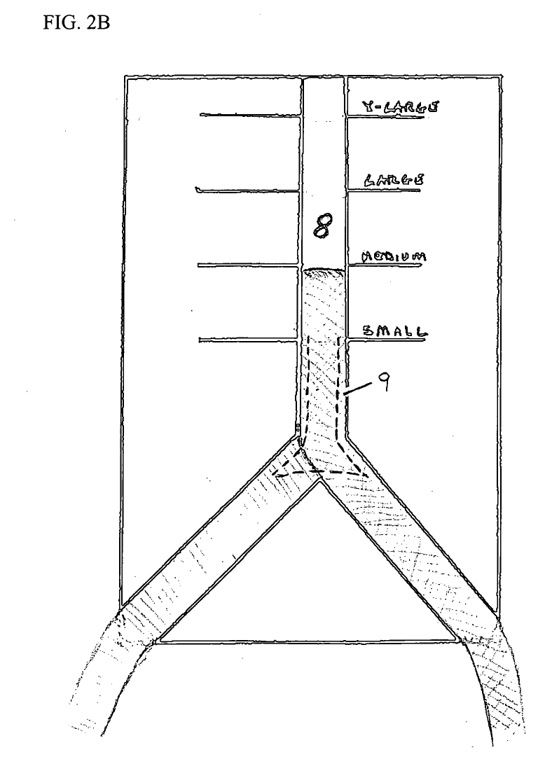

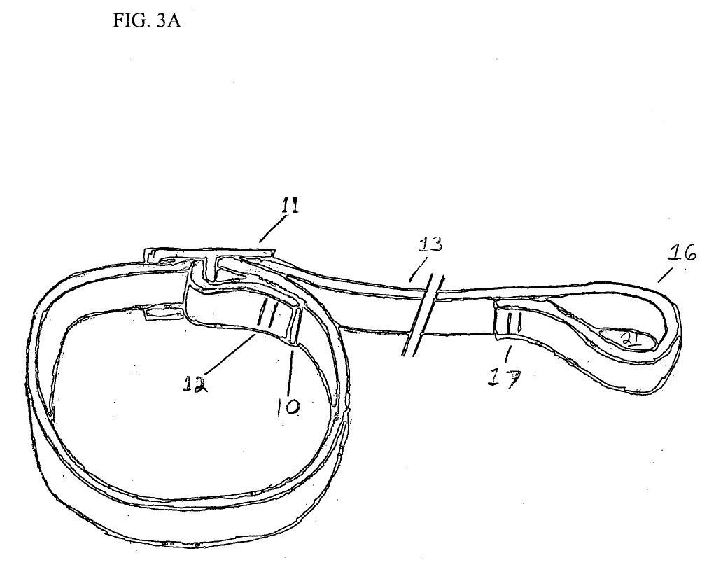

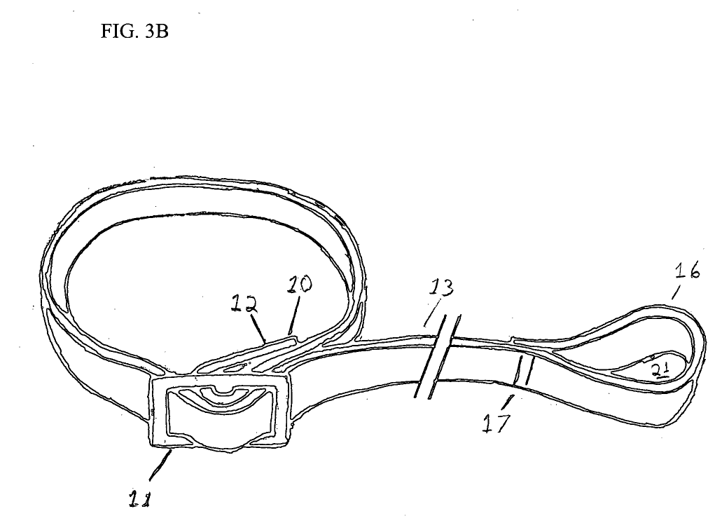

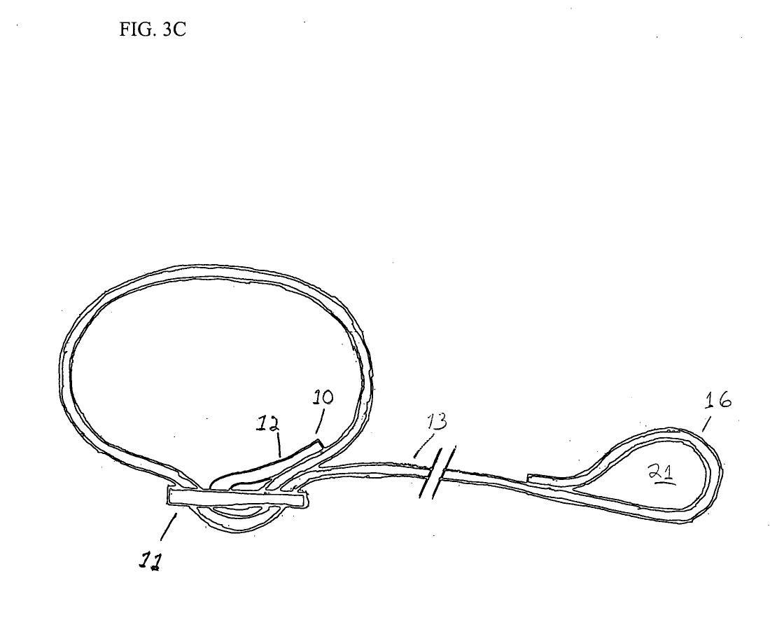

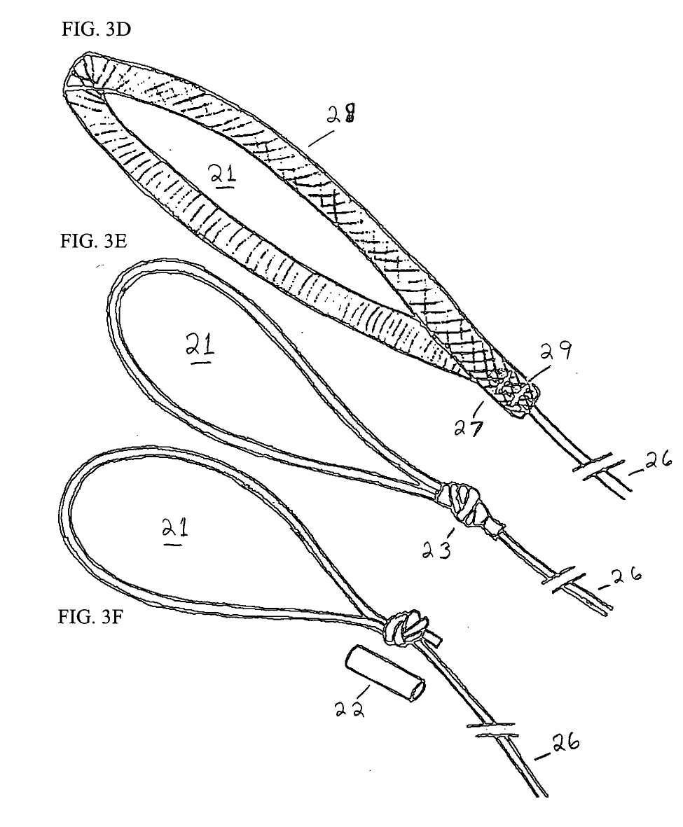

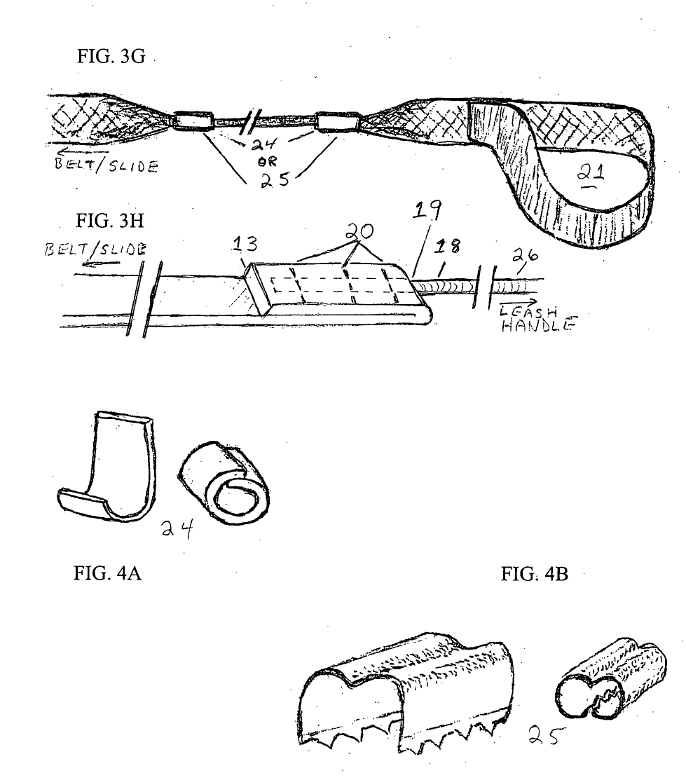

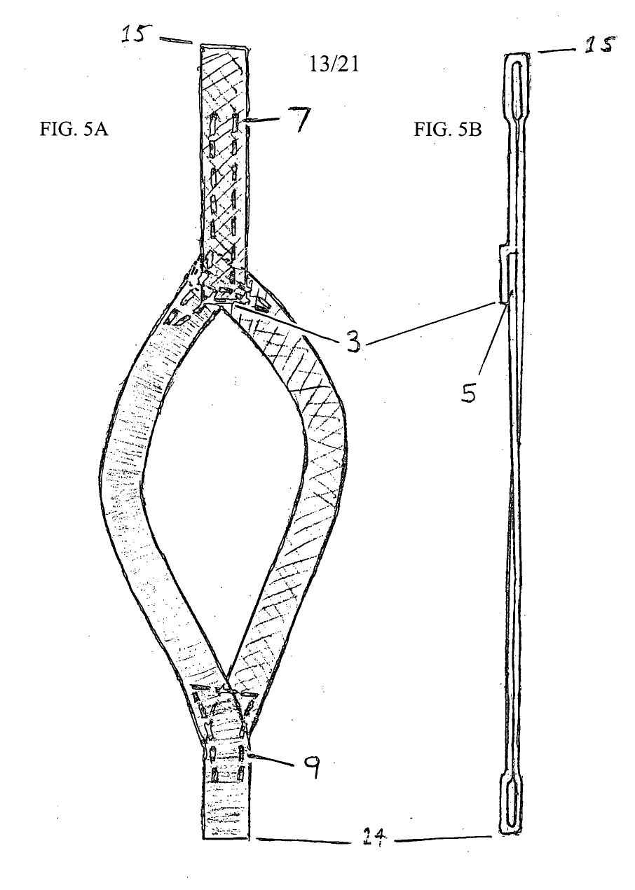

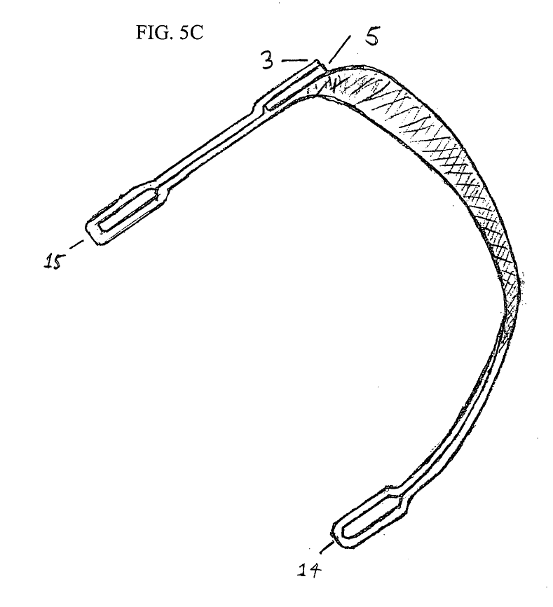

Keeping right side of belt toward table bring around so end (#13) can be inserted into and through belt loop (#15) Pull belt strap through loop (#15) until ˜½ belt remains between loop (#14) and loop (#15). Take end of strap (#13) and pass through slide (#11) as in (FIGS. 3A, 3B and 3C). Result should be a strap passing through the belt loops (#14 and #15) and the slide (#11) creating a closed loop (belt) without any twist in the strap comprising the belt Primary product will utilize (FIG. 3E). The end of the leash shock cord that is attached to the belt (FIG. 3H) can be used as the handle by creating a loop (FIG. 3E) by tying a knot in the folded over end of the leash. The belt/leash can convert to a cord (FIG. 3H) at the end of the belt strap (#13). The cord (#26) can then convert back to strap material to create the leash handle (FIG. 3D). (FIG. 3A-#16) The belt and leash can be one piece of strap that comprises the belt, leash and leash handle.

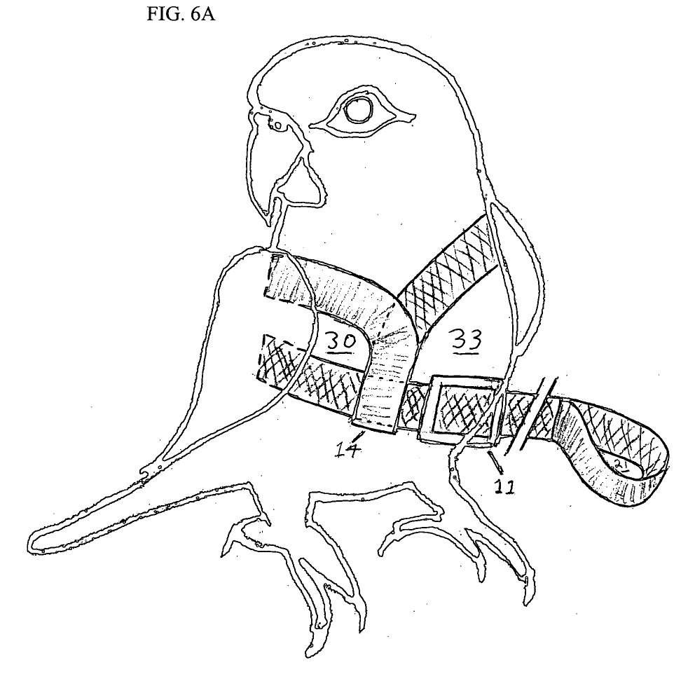

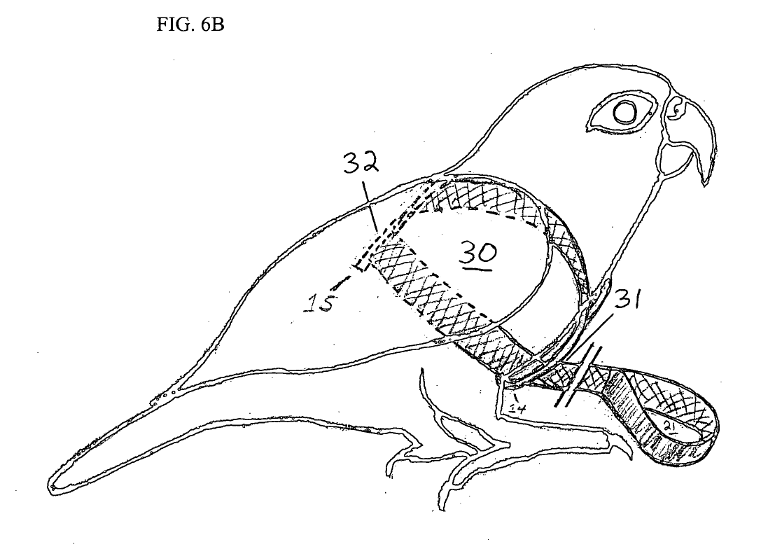

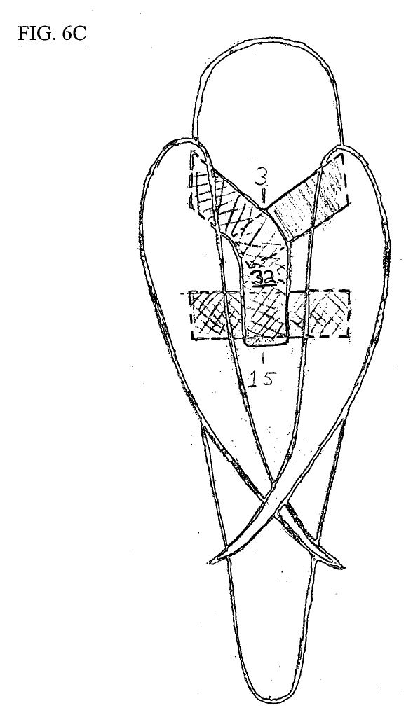

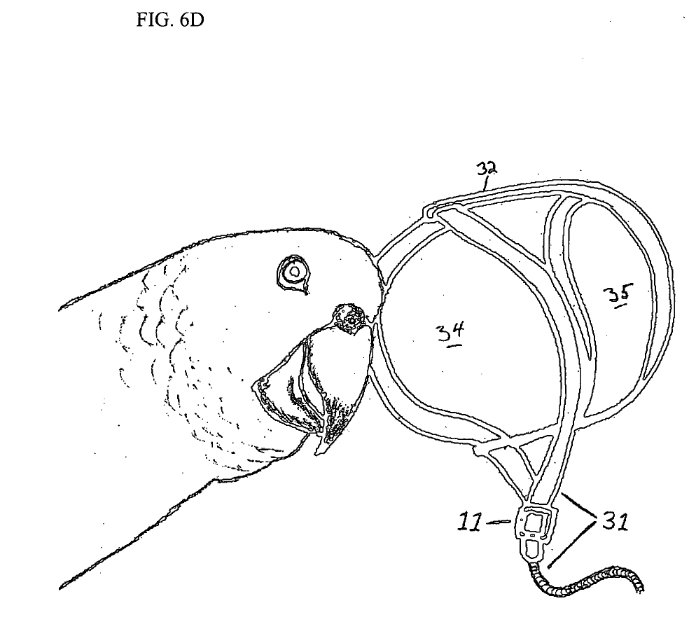

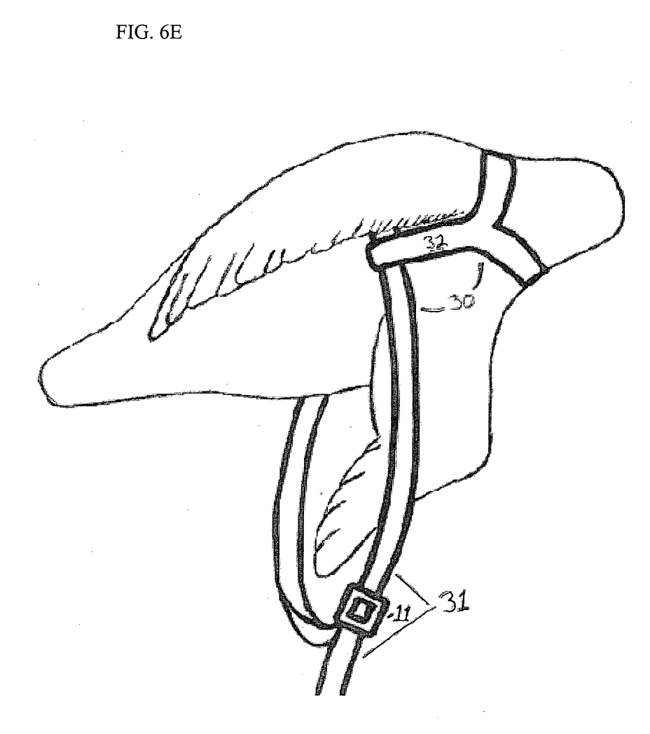

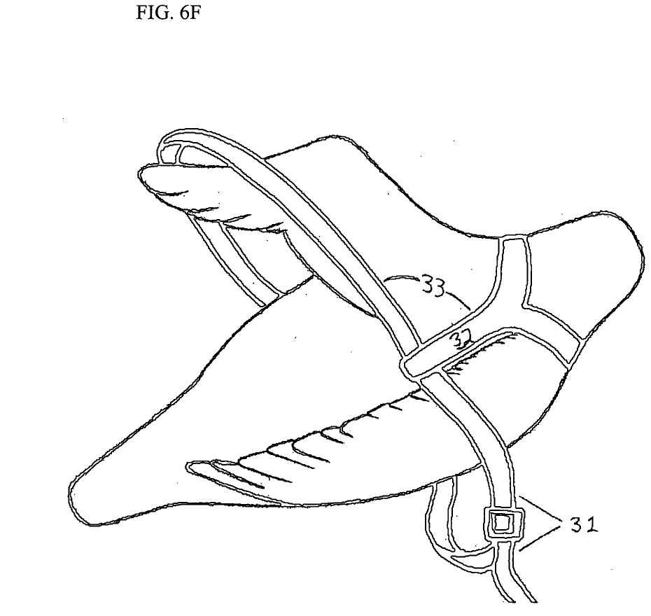

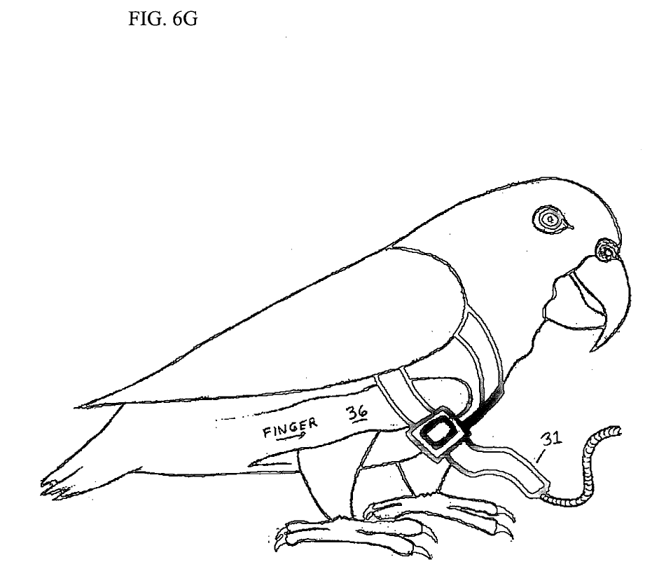

(FIG. 6D) Expand the belt of the harness, pulling leash (#31) through slide (#11) to a diameter large enough (#34) so that after you slip the belt and collar over the birds head, you can pull one wing through the space (#30). Creating space (#34) large enough to work requires drawing the leash through the slide (#11) until you reach the junction of the strap and shock cord (FIG. 3H). Place the bird in front of you on a stable surface. Right-handed owners face your pet to your right.

Orient harness assembly so the back of the harness (#32) is on top and the opened belt (#34) is directly in front bird. Move harness assembly toward bird passing the belt opening (#34) first, and the collar opening (#35) second, over birds head until the belt is around the wings and the collar rests on the neck of the bird. (FIG. 6E) With collar in place around the birds' neck, pick up right wing and pull through space (#30) between belt and collar. (FIG. 6F) Pull the left wing through space (#33). (FIG. 6G) Tighten belt by pulling leash (#31) through slide (#11). Tighten until belt is snug around the waist leaving just enough space to insert your index finger (#36), between the bird and belt, on medium size bird. Space is necessary for the belt to be loose enough for the bird to breath and for the slide to rotate from the chest to back.

I claim:

1. A bird restraint system consisting of an undetachable leash and a harness contraption made by one piece having a collar end and a belt end.

2. The bird restraint system in claim 1 wherein a lightweight material such as nylon is used to form the harness contraption.

3. The bird restraint system in claim 1 wherein only one slide is affixed to the harness contraption through which the leach slides to tighten the harness contraption.

4. The bird restraint system in claim 1 wherein the leash is made of a stretchable shock cord.

5. The bird restraint system in claim 1 wherein the belt end passes freely through the collar end which allows for free rotation around the body of a bird allowing the leash to adjust below or above a set of wings for walking versus flight of the bird.

6. The bird restraint system in claim 1 wherein the harness contraption is formed in an elliptical shape.

7. A method of applying a bird restraint system consisting of the steps of: Expanding a belt end of a harness contraption by pulling a leash through a slide to make the circumference of the belt end large enough to be slipped over a bird's head and wings; sliding the belt end and a collar end over the head of the bird; pulling the wings through an opening between the belt end and the collar end; placing the collar end on the back of a bird's neck; tightening the belt end by pulling the leash back through the slide.
